(19) United States
(12) Patent Application Publication
(10) Pub. No.: US 2006/0003708 A1
(43) Pub. Date: Jan. 5, 2006

(54) Slide able keypad

(76) Inventors: Joni Jantti, Oulu (FI); Tuomas Leinonen, Oulu (FI)

Correspondence Address: PERMAN & GREEN, 425 POST ROAD, FAIRFIELD, CT, 06824, US

(21) Appl. No.: 10/881,455

(22) Filed: Jun. 30, 2004

(51) Int. Cl. H04B 1/38

(52) U.S. Cl. 455/90.3

(57) ABSTRACT

A telephone (100) includes a first housing part (102) having a display device (104), a second housing part (106) having a first set of input keys (108), and a third housing part (110) having a second set of input keys (112). The first housing part is arranged between the second and third housing parts and mechanically joined to the second and third housing parts. The second and third housing parts are arranged to slide between at least a respective first position and a second position relative to the first housing part, where the respective first relative position is such that the display is substantially uncovered by respective second and third housing part where the respective second relative position is such that the display is substantially covered by the respective second and third housing part.

### FIELD OF THE INVENTION

The present invention relates to a telephone device having a keypad and a display that are configured in a sliding relation with respect to each other.

### BACKGROUND

Communication devices have during the last decades evolved from being more or less primitive telephones, capable of conveying only narrow band analog signals such as voice conversations, into the multimedia mobile devices of today capable of conveying large amounts of data representing any kind of media. For example, a telephone in a GSM, GPRS, EDGE, UMTS or CDMA2000 type of system is capable of functioning, more or less, like a computer terminal having a high resolution color display and a keypad with a large number of input keys. These multi media mobile devices are used to access services via the mobile network, including communication services that allows a user of the device to, e.g., perform web browsing.

While there has been a strong demand for increased functionality in terms of, e.g., increased display size for improved image rendering capability, there has also been a strong demand for increased portability in terms of decreased size and weight. Needless to say, these demands are typically not compatible. Present day multi media mobile devices are all compromise constructions, typically with designs that include compact keypads with a plurality of very small keys cramped together on a small surface area of a device. Another compromise construction has been to avoid the use of mechanical keys and instead use a touch sensitive display on which a stylus is used to input commands and write text.

Other compromise constructions include the Nokia 6820 Messaging Device, which includes a first and a second keypad that in a first configuration is facing each other and in a second configuration the second keypad is folded away from the first keypad. Such a construction does, however, provide limited flexibility in terms of design, as the folding capability of the device requires, for example, an intricately configured hinge unit.

Yet another compromise construction is described in the European patent application published with number 1107101, in which is disclosed an electronic device with a touch sensitive housing element that slides or is folded with respect to a main body of the device. A drawback with this construction is that it is not robust and is hence sensitive to rough handling.

### SUMMARY OF THE INVENTION

An object of the present invention is hence to provide a mobile telephone that overcomes drawbacks of prior art devices while facilitating for a user to use the telephone as a multi media communication device.

The object is achieved by way of a telephone according to claim 1.

A telephone according to the invention comprises a first housing part comprising a display device, a second housing part comprising a first set of input keys, and a third housing part comprising a second set of input keys.

The first housing part is arranged between said second and third housing parts and mechanically joined to said second and third housing parts. The second and third housing parts are arranged to slide between at least a respective first position and a second position relative to said first housing part, where the respective first relative position is such that said display is substantially uncovered by respective second and third housing part and where the respective second relative position is such that the display is substantially covered by said respective second and third housing part.

Such a telephone is both robust and allows the use of a large display, which is essential when using the telephone as a multi media communication device, when the housing parts are in the first relative position, while at the same time being compact when the housing parts are in the second relative position.

In a preferred embodiment, electric position detection means are arranged in the telephone for detecting the first and second relative positions and provide a position indication signal to electric circuitry in the telephone. These position indication signals can then be used by processing means in the telephone.

Preferably, at least one of said second and third housing part comprises a cut-out for providing an uncovered area of the display when said second and third housing parts are in the second position relative to the first housing part, thereby allowing a user to view part of the display even when the telephone is in the second mode of operation.

A preferred embodiment is that the second and third housing parts are substantially hollow and substantially encloses the first housing part when in respective second relative position relative to the first housing part. This has the advantage that the display, and other circuitry contained in the first housing part is protected from rough handling.

Also, in order to provide advantageous ease of use, the telephone the first, second and third housing parts, where the resilient means comprises activation means for enabling a user to slide the housing parts between the first and second relative position.

### BRIEF DESCRIPTION OF THE DRAWINGS

FIG. 1a schematically illustrates a front view of a telephone according to the invention when in a first mode of operation.

FIG. 1b schematically illustrates a side view of a telephone according to the invention when in a first mode of operation.

FIG. 1c schematically illustrates a front view of a telephone according to the invention when in a second mode of operation.

FIG. 1d schematically illustrates a side view of a telephone according to the invention when in a second mode of operation.

FIG. 2 is a functional block diagram of a telephone according to the invention.

### PREFERRED EMBODIMENTS

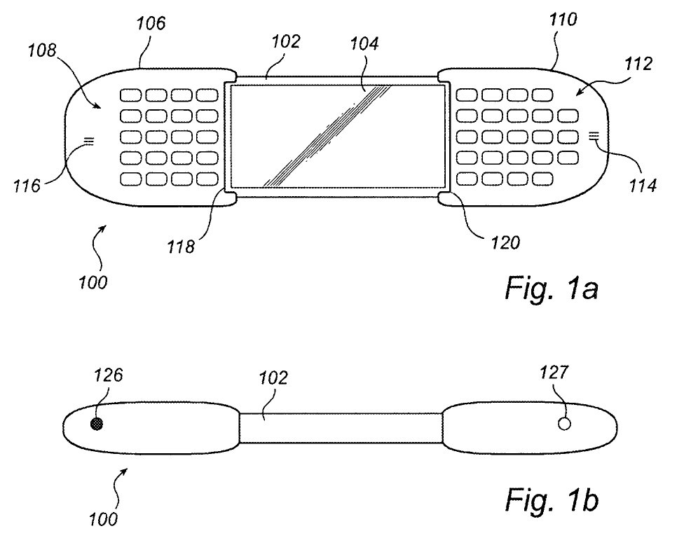

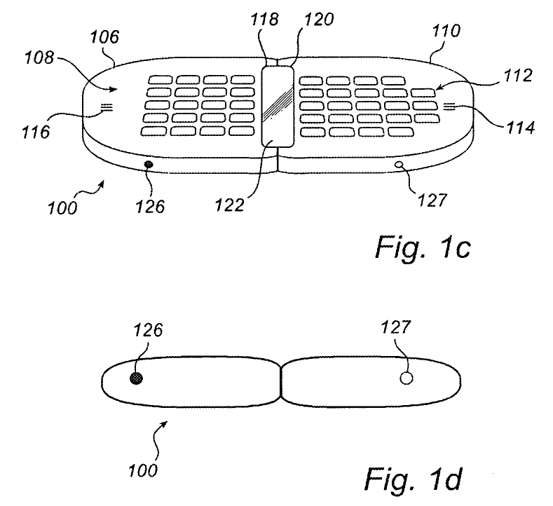

A telephone 100 comprising three housing parts, a first housing part 102, a second housing part 106 and a third housing part 110 is shown in FIGS. 1a-1d. The first housing part 102 comprises a display 104, the second housing part 106 comprises a first keypad having a first set of input keys 108 and a loudspeaker 116, the third housing part 110 comprises a second keypad having a second set of input keys 112 and a microphone 114.

The second housing part 106 and the third housing part 110 are mechanically connected to the first housing part 102 via mechanical connection means (not shown) that allow sliding of the housing parts relative to each other. Each of the second 106 and third 110 housing parts are substantially hollow, thereby allowing the first housing part 102 to be enclosed by the second 106 and third 110 housing part, as shown in FIGS. 1c and 1d. Each of the second 106 and third 110 housing parts also comprises mechanical actuation means in the form of buttons 126 and 127. These buttons 126, 127 allow a user to actuate resilient sliding means (not shown) that slides the housing parts 102, 106, 110 with respect to each other.

In FIGS. 1a and 1b, the housing parts 102, 106, 110 are in a first relative position with respect to each other where the display 104 is substantially uncovered. The telephone 100 can hence, in FIGS. 1a and 1b, be considered as being in a first mode of operation in which a user is capable of fully interacting with the telephone 100, e.g. using the telephone 100 to view images and browse the web.

In FIGS. 1c and 1d, the housing parts 102, 106, 110 are in a second relative position with respect to each other where the display 104 is substantially covered. That is, except for a limited area 122 as defined by cut outs 118 and 120 of the second 106 and third 110 housing part, respectively, the display 104 is not visible. The telephone 100 can hence, in FIGS. 1c and 1d, be considered as being in a second mode of operation in which a user is capable of more limited interaction with the telephone 100, as compared with the situation in the first mode of operation. For example, in the second mode of operation, the limited area 122 of the display 104 may show only a few lines of text or any other limited amount of graphic content.

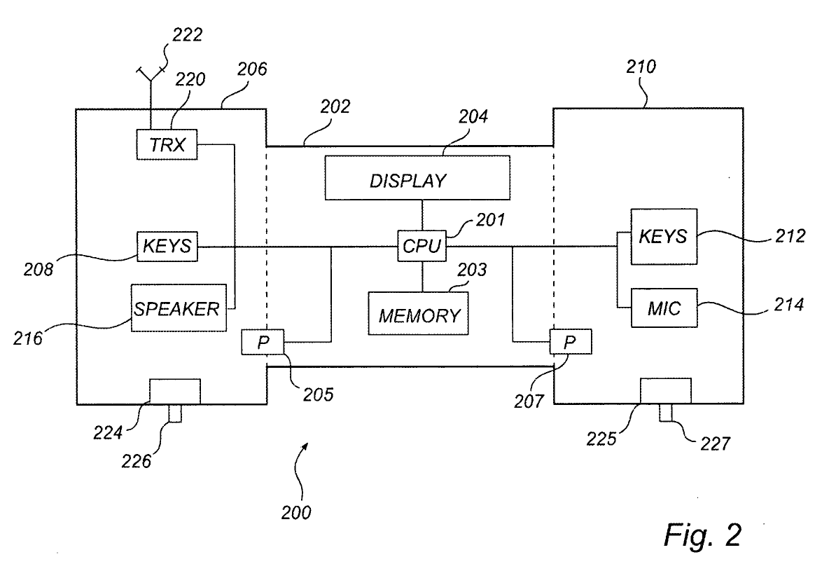

FIG. 2 shows a block diagram of a telephone 200 according to the present invention. The telephone 200 comprises three housing parts, a first housing part 202, a second housing part 206 and a third housing part 210.

The first housing part 202 comprises a processing unit 201 connected to a memory unit 203 and a display 204. The second housing part 206 comprises a number of electronic blocks: an antenna 222 connected to a transceiver 220, a speaker 216, a first keypad 208 and a speaker 216, all of which are connected to the processing unit 201 of the first housing part 202. The third housing part 210 comprises a microphone 214 and a second keypad 212, both of which are connected to the processing unit 201 of the first housing part 202.

No detailed description will be presented regarding the specific functions of the different blocks of the telephone 200. In short, however, as the person skilled in the art will realize, the processing unit 201 controls the overall function of the functional blocks in that it is capable of receiving input from the keypads 208, 212, audio information via the microphone 214 and receive suitably encoded and modulated data via the antenna 222 and transceiver 220. The processing unit 201 is also capable of providing output in the form of sound via the speaker 216, images via the display 204 and suitably encoded and modulated data via the transceiver 220 and antenna 222.

The second housing part 206 and the third housing part 210 are mechanically connected to the first housing part 202 via mechanical connection means (not shown) that allow sliding of the housing parts relative to each other, as discussed above in connection with FIGS. 1a-1d. The second housing part 206 and the third housing part 210 also comprise, respectively, a resilience unit 224 and 225, each having an actuation button 226 and 227 for actuating the resilience unit 224, 225 in order to slide the housing parts 202, 206 and 210 with respect to each other.

Two position sensing units 205, 207 are located in the first housing part 202 and configured such that they transmit electric signals to the processing unit 201 indicating the respective relative position between the first housing part 202 and the second 206 and third 210 housing part, respectively.

It is to be noted that the different blocks that have been described above are functional blocks and do not necessarily correspond to actual hardware units in a one-to-one relationship. As the skilled person will realize, functionality comprised in the blocks of FIG. 2 may, wholly or in part, be comprised in one or more integrated circuits in the form of any mixture of programmable and non-programmable circuits. Moreover, as the skilled person will realize, the processing unit 201, the memory unit 203, the transceiver 220 and the antenna 222 may be located in any of the housing parts 202, 206, 210.

1. A mobile telephone (100, 200) comprising a first housing part (102) comprising a display device (104), a second housing part (106) comprising a first set of input keys (108), and a third housing part (110) comprising a second set of input keys (112), where:
said first housing part is arranged between said second and third housing parts,
said first housing part is mechanically joined to said second and third housing parts,
said second and third housing parts are arranged to slide between at least a respective first position and a second position relative to said first housing part, where said respective first relative position is such that said display is substantially uncovered by said respective second and third housing part and where said respective second relative position is such that said display is substantially covered by said respective second and third housing part.

2. The telephone according to claim 1, where electric position detection means (114) are arranged in the telephone for detecting said first and second relative positions and provide a position indication signal to electric circuitry (116) in the telephone.

3. The telephone according to claim 1, where at least one of said second and third housing part comprises a cut-out (118, 120) for providing an uncovered area (122) of the display when said second and third housing parts are in said second position relative to said first housing part.

4. The telephone according to claim 1, where said second and third housing parts are substantially hollow and substantially encloses said first housing part when in said respective second relative position relative to said first housing part.

5. The telephone according to claim 1, where resilient means (124) are arranged in connection with said first, second and third housing parts, said resilient means comprising activation means (126) for enabling a user to slide said housing parts between said first and said second relative position.
